(19) United States
(12) Patent Application Publication
(10) Pub. No.: US 2015/0280765 A1
(43) Pub. Date: Oct. 1, 2015

(54) COMMUNICATION DEVICE MANAGEMENT

(71) Applicant: Wyless Group Holding (Suisse) SA, Bursins (CH)

(72) Inventor: Christopher G. Lowery, Rolle (CH)

(73) Assignee: Wyless Group Holding (Suisse) SA, Bursins (CH)

(21) Appl. No.: 14/434,306

(22) PCT Filed: Oct. 11, 2012
(86) PCT No.: PCT/EP2012/070179

§ 371 Date: Apr. 8, 2015

(51) Int. Cl. H04B 1/3816; H04L 29/08; H04W 76/02

(52) U.S. Cl. CPC H04B 1/3816; H04W 76/022; H04L 67/306; H04W 88/02

(57) ABSTRACT

The present invention relates to a mobile communications network node comprising package switched communication ability, the network comprising: one or several mobile stations or devices, one or several service providers providing communication with said mobile stations, wherein the mobile communication netwok node comprises means arranged to provide a mobile station with instructions, which is arranged to communicate with an agent comprising a programmable control unit in the mobile station to provide instructions for the configuratin and management of the mobile station.

### TECHNICAL FIELD

The present invention relates to a communications network, especially a mobile communications system, and in particular a package switched network, such as a GPRS, 2G, 3G, 4G, or EDGE or other cellular based or satellite communications network for the two way transmission and real time management of data travelling between one or more mobile devices over networks operated by one or more service providers in one or more than one country belonging to one or more 3^{rd} party users. This technology is known as Machine to Machine Communication, or M2M.

### BACKGROUND

The number of users of mobile networks and services is increasing rapidly and users are demanding more and more sophisticated applications and solutions, often on a global basis. Development of global M2M wireless applications has resulted in a rapidly expanding number of devices under remote management providing a wide variety of solutions in various industries. The desire of companies, either OEMs, distributors or end users to develop more and more solutions to expand their enterprise WAN or LAN to include all remote devices is a new phenomenon described as improving Time to Market and these companies are labelled as Real Time Enterprises.

New applications and solutions are created within a wide range of industries virtually every day. It is now becoming generally accepted that any remote piece of equipment may be enhanced by being connected, via a remote device, to the enterprise WAN or LAN of the OEM, or to that of the end customer or other authorised entity involved in the manufacturing or distribution chain and permitting constant two-way access to and from these devices. This may be to provide the real time data required to improve business logistics, or to permit remote monitoring of functionality or to fulfil maintenance for guarantee or upgrades for improved functionality to a piece of equipment, thus reducing carbon footprint created by human intervention and creating an additional low cost revenue stream, or for any other reasons which can be valuable either to the manufacturer, to the user, or any other involved entity.

In this real time data environment, the network on which the device sits is interlinked to the public Internet so that the data can then be retransmitted from the server in IP form over the public Internet and provided to the OEM, MNO, end customer, or other authorised entity involved in the network in the form of a web based display. This concept of connecting virtually every piece of equipment to the enterprise WAN or LAN and managing the equipment over the Internet is called ‘The Internet of Things’.

The applications and solutions which become available by this technology may require instructions to be provided either directly to the SIM in the device, for example auto connect, configuration, disconnect or to seamlessly switch network APNs to another designated service provider, or to the module in the device or to the device itself, for example to create or modify user profiles and protocols in accordance with the rules engines of the device in question, or to conform to service providers' differing technologies, eg 2G, 3G, 4G, Edge, etc, or applications, like GPS, or motion detection, or to set up other SIM configurations like sleep mode, fall back mode, etc, some of which instructions will be transmitted to the SIM.

Some of these requirements can be resolved by the use of a ‘special’ SIM, for example a SIM which is pre-profiled with a number of dedicated APN identities of service providers whose network is interconnected to the mobile network.

Some of these requirements are presently resolved by the use of an ‘intelligent’ device, which has the ability to be programmed with a set of instructions prior to deployment and activation. Intelligent devices are substantially more costly than basic or ‘dumb’ devices, which do not have programming capability and are restricted to carrying out basic ‘Native’ AT (NAT) commands.

Dumb devices cannot be upgraded to intelligent status in the event that the manufacturer or the end user wishes to introduce a more sophisticated solution or to improve functionality after the device has been deployed and activated.

Upgrading of intelligent devices after deployment and activation may also be limited to the available set of instructions preloaded into the device and it may not be possible to introduce new instructions if they have not been previously foreseen.

Both dumb and intelligent devices must be manipulated manually prior to deployment in order to load whatever level of basic or sophisticated instructions are required for the management of the SIM, to configure the device profiles and the execution of the application or solution. This is a time consuming and costly process.

Manufacturers of devices do not have standard rules, protocols, procedures, interfaces or systems and manual manipulation before deployment of each manufacturer's devices requires a different procedure in each case.

A deployment of devices on a global basis, into many countries around the world, requires specific instructions as to the connectivity aspect, device profile configuration aspect, service provider's network technology, the applications and solutions aspect, the SIM behaviour aspect, the monitoring and reporting aspect and the potential upgrade aspect.

These instructions presently have to be incorporated into the device which requires the use of a more costly intelligent device and custom set up of the device before deployment, in accordance with the rules, procedures, interfaces and systems of the specific device type, which again involves costly and time consuming manual intervention.

The instructions are required so that constant two-way access to and from these devices can provide the real time data required to improve business logistics, regular monitoring and management, or to create additional revenue streams, thus creating a viable ROI on the cost of deploying such a network of devices. The deployment, activation, configuration and continuous monitoring and management of many thousands of devices in many countries around the world require a more inventive technological approach than is presently available.

P17688SE provides a solution to the problem of transferring the connection of SIMs in devices from a costly roaming network to a local network by seamlessly mapping private Fixed IP addresses to all devices connected to the network to initiate transmission to or from the device or to request devices to initiate transmission amongst themselves, as each device has a fixed IP address, and thus the identity remains constant and is known always to the network and to all other devices. The solution provides the ability to interconnect a mobile network to many service providers' networks by using their dedicated Access Point Nodes, (APNs), and to manage each of these interconnects individually and simultaneously to provide access by third party users to any or all of these operators' networks individually and simultaneously from one fixed point of access with the ability to manage hand over of service from one cellular service provider to another, or to a satellite or other mobile network outside of the cellular networks' global footprint seamlessly whilst maintaining the IP addresses of the devices unique and constant.

The solution requires the allocation of fixed IP addresses to those devices connected to the network which may require hand over of service from one operator to another.

In practise, this requires the allocation of fixed IP addresses to all devices connected to the network if they are to be deployed globally, or could roam between networks and could therefore potentially require hand over of service from one operator to another.

The allocation and management of fixed IP addresses requires a more sophisticated network than using non-fixed IP addresses and is more costly.

Not all M2M data travelling over cellular networks is highly valuable, confidential and business critical information which must conform to levels of privacy and security.

The solution is more suited to such business critical uses than for many applications for data usage which is not of such critical importance.

The solution requires a special SIM which is pre-profiled with a number of dedicated APN identities of service providers whose network is interconnected to the mobile network.

The solution is restricted to the allocation and management of fixed IP addresses and the handover of service from one cellular service provider to another, or to a satellite or other mobile network outside of the cellular networks' global footprint and does not address other requirements of the SIM or the device.

The solution is restricted to the management of the connection of the SIM between mobile networks and provides no improvement in the SIM set up procedures required before or after the deployment of the device.

The solution does not address other aspects of the SIM behaviour, for example, auto connect and configuration, deactivation, sleep mode, fall back mode, etc, which may, depending on the network capability, require manual intervention or instructions from an intelligent device.

The solution does not address the problem of configuration of various types of devices and the manual intervention presently required to customise them according to their manufacture.

The solution does not address the problem of different network technologies used by service providers, including but not restricted to 2G, 3G, 4G, EDGE etc.

The solution does not address the procedures for introduction of applications instructions into the device and the manual intervention presently required to customise them for specific applications and solutions.

The solution does not provide any remote management capability over the device after deployment.

The solution does not address the problem of differing levels of capability in various types of devices—dumb or intelligent, which creates a substantial cost differential and which can limit the solutions capability.

The solution does not permit the upgrading of a dumb device to an intelligent device.

The solution does not provide for customisation, upgrading, or management of any other function of a device without manual intervention, either before or after deployment.

The solution does not provide a way of creating a generic table for devices in order to conform them to standard instructions and functions which permit customisation by cost effective, simple, standard, remote means after deployment.

The solution does not provide any cost advantages over existing manual or remote manipulation of the device or the SIM.

### SUMMARY

What is needed is a true two-way secure, real time, efficient and multi-standard mobile communication network, with ability of connecting to GSM, GPRS, UMTS, 3G or 4G networks operated by local operators in many different countries and managing services and connectivity of many types of devices connected to dedicated package based networks from a single point of entry and control.

Also, this single point of entry and control made possible by the network on which the device sits being interlinked to the public Internet so that instructions and data can be transmitted or retransmitted from the server in IP form over the public Internet and received from or provided to the original equipment manufacturer (OEM), Mobile Network Operator (MNO), end customer, or other authorised entity involved in the network, e.g. in the form of a web based display.

Also, a management platform, linked by the Internet to the network, with ability to communicate with the server, the SIM and the device, either separately or simultaneously as instructed by the network from a single point of entry by remote management to manage the network connections, the configuration and applications instructions of the SIM and the device as received from an authorised entity and the data received from the SIM or the device by substantially constant two-way access.

Also, any type of SIM and mobile station or device, at the lowest possible cost, initially configured to contain only basic NAT instructions at deployment for SIM registration and activation of auto connect on the home operator's network APN address, (the original service provider who's APN address is profiled into the SIM at the time of deployment), and capable of receiving further configuration and applications instructions from a server in IP form over the Internet or via any protocol used by the Mobile Network Operators, (MNOs), after deployment.

Also, the mobile station or device being capable of subsequently receiving instructions remotely to programme and re-programme the SIM and the device as necessary as to SIM connectivity and device configuration and applications, on any type of network in any geographical region as instructed by the network applications server from a single point of entry and control via a web based network, operated by the OEM, MNO, or other authorised entity.

Also, with ability of permitting standardisation of configuration of SIMs, modems and various types of devices with a minimum level of information at the lowest possible cost prior to deployment on any network in any geographical territory.

Such an invention is valuable, innovative and necessary in view of the substantial increase in global M2M wireless applications serving many industries with a variety of equipment, devices and customised solutions in many geographical locations and the consequent carbon footprint that would be created in the event of requiring manual intervention to manage this equipment and devices.

Consequently, a first aspect of the invention is the ability to interconnect a mobile network to many service providers' networks by using their dedicated Access Point Nodes, (APNs), and to manage each of these interconnects individually and simultaneously to provide access by third party users to any or all of these operators' networks individually and simultaneously from one fixed point of access and to connect many mobile stations, or devices, of various types to the mobile network.

A second aspect of the invention is that the mobile network on which the mobile stations or devices are deployed is interlinked to the public Internet so that instructions can be transmitted to the devices from the network server in IP form and data can be retrieved from the devices over the public Internet and operated by the OEM, MNO, or other authorised entity.

A third aspect of the invention is that every device connected to the mobile network is equipped with a control unit, a micro processor or the like, also known herein as an ‘agent’, which is equipped with a programmable language which can receive and communicate instructions required for the management of the device and the SIM. The agent effectively acts as the device management platform.

A fourth aspect of the invention is that the control unit or agent may be integrated into the modem of the device, or connected to an electronics carrier such as a printed circuit board of the device, which makes it an integral part of the device, also permanently connected to the SIM and the modem.

A fifth aspect of the invention is that the agent is able to receive instructions in a programmable language and communicate the instructions to the SIM, the modem or the device in the form or language required by each of them.

A sixth aspect of the invention is that, at deployment of the device, the modem may contain only the basic NAT instructions to ensure registration of the SIM with the home operator's, (original service provider's), APN address profiled in the SIM, to enable activation of the SIM auto connect function and connection to the mobile network to then permit two way communication between the device and the OEM, MNO, or other authorised entity for transmission of instructions and data.

A seventh aspect of the invention is that, at deployment of the device, the agent may contain only the same basic NAT instructions to ensure registration of the SIM with the home operator, then to activate the SIM auto connect function and connection to the mobile network to then permit two way communication between the device and the OEM, MNO, or other authorised entity for transmission of instructions and data.

An eighth aspect of the invention is that if, for whatever reason, auto connect is not accomplished by the home operator when the SIM registers, the agent is capable of assisting with auto connect by means of the basic NAT instructions contained in it which can be communicated to the operator via the modem.

A ninth aspect of the invention is that neither the SIM nor the device nor the modem in the device needs to be preloaded with more sophisticated configuration instructions, applications or connectivity features which would require a more intelligent and costly device or SIM than under this invention.

A tenth aspect of the invention is that the agent may be programmed to receive or send data and instructions from a server via an (IP) tunnel to be set up between any third party user and the modem in the device, or via an open session, using UDP or any other MNO protocol and to translate the instructions to pass to the SIM, the device or the modem in the device.

According to an eleventh aspect of the invention, the agent may be programmed in C++, Java or any other programming language suited to the purpose.

According to a twelfth aspect of the invention, a management platform is connected to the network, connecting it to the server, the firewalls and the router, permitting it to communicate with the agent in IP form or otherwise via the modem and enable management of the agent's functions by the OEM, MNO, or other authorised entity through a web based interface.

According to a thirteenth aspect of the invention, an applications server is connected to the mobile network which can access from a data base, instructions and information concerning:
a. customer information and configuration and connectivity of all SIMs and devices and implementation of applications to be executed by the devices,
b. a table of Access Point Nodes, (APNs) applicable to the various operator networks which are connected to the mobile network,
c. a table of configuration rules for a variety of devices of many manufacturers.
d. a ubiquitous interface to facilitate configuration of any device to any of the technologies used by the various operator networks which are connected to the mobile network,
e. tables of the applications instructions available to provide solutions for a variety of devices to fulfil a variety of vertical industrial uses.

According to a fourteenth aspect of the invention, the agent can identify the identity of the device in which it is implanted and immediately after registration and activation of the SIM the agent can inform the server which then knows which set of rules to consult for configuration of the device and for assimilation of the service provider's technology.

According to a fifteenth aspect of the invention, the server may consult the customer information in the data base available to identify which devices belong to that customer and which connectivity, configuration and applications are applicable to that customer's devices.

According to a sixteenth aspect of the invention, the agent can then receive additional, new or modified instructions from the server remotely in IP form over the public Internet, or otherwise, and can be instructed, via the management platform, by the OEM, MNO, or other authorised entity from a web based access point, or otherwise, to configure and load the connection and applications instructions applicable to that device from the server and communicate them to the modem or to the SIM.

According to a seventeenth aspect of the invention, connection, configuration and applications instructions will be specific to the device type, location and purpose, as derived from the tables of APNs, device and technology rules, customers and applications instructions contained in the server in accordance with the identity of the device signalled by the agent.

According to an eighteenth aspect of the invention, the instructions received by the agent will be received via the modem, translated and applied directly to the device or to the SIM via the modem or through the electronics carrier, eg the printed circuit board, depending on the configuration of the device.

According to a nineteenth aspect of the invention, in respect of SIM connectivity, the agent can:
a. manage the interconnection of the device to one of the service providers' networks connected to the mobile network by using the customer information and the dedicated Access Point Nodes, (APNs), which are available in the table in the server,
b. manage each of these interconnects individually and simultaneously to permit selection of any or all of the operators' networks individually and simultaneously from one fixed point of access,
c. manage the seamless handover of the SIM and the device from one operator to another by permitting the home operator to configure a hand off to the agent, acting as the device management platform, so that the auto connect function can hold the call and reconfigure the device over the air to a new operator,
d. Manage the reconfiguration of the device to accommodate a different technology, eg moving from 2G to 3G or to 4G etc.

According to a twentieth aspect of the invention, data received from the device can be retransmitted from the server in IP form over the public Internet, or otherwise, via the management platform and provided to the OEM, MNO, ultimate customer or other authorised entity in the form of a web based or other type of display.

According to a twenty-first aspect of the invention, the data may be organized by the management platform in the form of a back office function and provided to any authorised entity in the form desired, with additional optional services attached, including:
a. reports provided by the management platform may contain any data available from the mobile network. Examples are SIM activity, data analysis and statistics, location reports, billing details, etc,
b. access to the data may be limited in accordance with priorities established by the customer,
c. warnings of excess data usage per device or SIM compared to information contained in the customer information file.

According to a twenty-second aspect of the invention, if the device exceeds data usage as limited per the customer file, the server can instruct the agent to disconnect the SIM from the network in order to prevent excess costs being incurred. Excess usage of this type is caused by a ‘rogue SIM’, which may be deficient or may have been the victim of hacking or SPAM.

According to a twenty-third aspect of the invention a network is provided allowing a two-way Internet protocol (IP) tunnel to be set up between any third party user, any device installed with a SIM card and an agent and any service connected to a server. The data travelling between the device and server can be encrypted and compressed in the server, and the device can be directly controlled and managed by the OEM, MNO, ultimate customer or other authorised entity, over the public Internet via the management platform and delivered in the form of a web based display, or in another form, providing the user with direct access to all devices, thus providing an increased simplicity of deployment and configuration, management of the device operations, increased speed of transmission, reduced cost of transmission and increased security of transmission.

Moreover, the invention provides for:
Ability to use standard SIMs, modems and devices with only basic NAT levels of instruction at the time of deployment.
Ability to instruct the modem to know where to call to register the SIM on the home operator's network and permitting the operator to configure a hand off to the agent, acting as the device management platform, so that the auto connect function can hold the call and configure the device over the air.
Ability to assist with auto connect of the SIM to the home operator's network,
Ability to communicate to the network the identity of the device immediately after auto connect to the home operator network,
Ability to store all information and instructions required by the SIM and the device for configuration, connectivity and user applications in a network server and not in the SIM or the device.
Ability to transmit information and instructions to a device from a server in IP form over the Internet or via any protocol used by the Mobile Network Operators, (MNOs), after deployment.
Ability to select from a global choice of operator networks using multiple dedicated APN addresses contained in a data base in the mobile network server,
Ability to ship and deploy devices from a central manufacturing or shipping source pre-tested and pre-equipped to connect to a local network in the country of use,
Ability to pre-test devices on the home operator's network and ship and deploy them in “sleeping mode”, to be woken up, auto-connected and reconfigured remotely to connect to a new operator when activated by the user,
Ability to apply any number of APN profiles corresponding to service providers contained in a data base in the network server and supplied to the agent,
Ability of the network to recognise the identity of the device and to match it to the APN profile of the required operator's network contained in the server table,
Ability by the network to instruct the agent to select the designated APN in accordance with the identity of the device received from the agent and the device and customer information stored in a data base in the server,
Ability of the agent to manage the seamless transfer of connection from one operator's network to another, including facilitation of transfer between differing technologies, 2G, 3G, etc,
Ability of the agent to disconnect a SIM connection from an operator's network in the event of costly excess data usage.
Ability by the network to recognise the identity of the device and provide instructions to the device via the agent for user applications over the air from a network server after deployment and auto connection,
Ability by the network server to store in a data base generic rules for configuration and applications covering a variety of different manufacturer's devices to facilitate customisation of the device configuration,
Ability to provide a dumb, less expensive device with the intelligence capability presently only available in a more costly intelligent device,
Ability to segregate and manage batches of devices by network and by user within network with secure ring-fencing to prevent unauthorised access and ensure authentication and security,
Ability by the network server to contain in a data base tables of applications relating to various industry requirements,
Ability by the network server to contain in a data base specific customised applications for user requirements to be supplied to specific devices,
Ability to assume management of SIM and device management of all of the above features as instructed by the network from a single point of entry and control through a web based or other type of management platform connected to the mobile network,
Use of the management platform to provide web based or other reports and statistics from all available data in the network to any authorised person.
Extension of the users' network recognition from fixed line to mobile devices without requiring network solutions for communications with mobile devices,
Single point of network entry and single technology standard for global use,
Adaptability for all existing and future standards, including GPRS, EDGE, UMTS, 2G, 3G, 4G etc.,
Ability to monitor, manage and provide maintenance or upgrades to remote equipment without dispatching physical persons with consequent cost effect and impact on the environment and carbon footprint.
Ability to maintain communication to the device in handover to other cellular or non-cellular networks,
Ability to compress and encrypt data to accelerate transmission and increase security,
Ability by the OEM, distributor or user to manage all connectivity and application features of the device and to achieve global cost effective deployment of many pieces of equipment.
Ability by the OEM or distributor to provide additional services to the user thus improving the ROI on global deployment of many devices.

For these reasons, a mobile communications network node for use in a communication network is provided. The node comprises a package switched communication ability, the communication network comprising: one or several service providers, providing communication through one or more networks with the communications network, one or several mobile stations or devices which can be connected to any of the networks, characterised in that the mobile communications network node comprises means arranged to provide a mobile station with instructions, which is arranged to communicate with an agent, comprising a programmable control unit in the mobile station, to provide instructions for the configuration and management of the mobile station.

In one embodiment, the means in the node is a server, which contains in a database one or several of: tables of Access Point Name, APN, addresses of operator networks connected to the mobile communications network; a ubiquitous interface to facilitate configuration of devices in accordance with the technology used by the operator networks; tables of configuration rules of various types of modems in mobile stations from various manufacturers; tables of instructions in respect of many vertical industry applications; or customer files containing the unique identity number of all customer devices deployed upon the network. Preferably, the unique identity is International Mobile Equipment Identity, IMEI, number of the mobile stations. The server may further contain information concerning one or several of: an APN address of a home service operator's network profiled into a SIM in each mobile station; designated APN addresses for SIM connectivity of all mobile stations according to their geographical and/or additional aspects of deployment, including network technology; configuration of all mobile stations in accordance with a manufacturer's and user requirements; or applications instructions for all mobile stations in accordance with user requirements. The server is configured to communicate with the agent via a modem by means of an IP-tunnel to be set up between the server and the device, or via an open session, using Users Datagram Protocol, UDP, or a Mobile Network Operator, MNO, protocol over the Internet. The server may be able to communicate with an agent in order to execute one or several of: remotely monitor registration and auto connect of the SIM in the device to the home operator's network; assist in registration and auto connect of the SIM in the device to the home operator's network in the event of failure; provide instructions for the configuration of the device from the rules contained in the server data base and in accordance with the technology used by the operator network; provide instructions for the transfer of connectivity of the SIM in the device from the home operator's network to another designated network in accordance with the information contained in the customer file and the tables of APN addresses; provide instructions for the loading of applications instructions into the device in accordance with the information contained in the customer file and the tables of vertical applications. Preferably, the mobile station comprises a SIM card which has the following characteristics: the SIM card is profiled with a network APN address which is the home operator's APN address, provided through the original service provider network, the SIM card may be separate or imprinted on or embedded directly into the body of the mobile station or modem, the SIM card may be registered with a home operator's network via a modem to permit auto connect to that network; the SIM card is permanently connected to the control unit in the mobile station and is in constant communication with the control unit; the SIM card is assisted to connect to the home operator's network by the control unit in the event of failure to auto connect.

The connection of the SIM card is subsequently transferred from a home operator's network to a designated network connected to the mobile communications network when instructed by the server of the network, via the control unit, in accordance with the information contained in the customer file and the APN tables. After connection of the SIM to the home operator's network, maintains constant access to the mobile station and vice versa by the control unit, which acts as a device management platform. The SIM is disconnected from the network by instructions from the server to the control unit if the data usage is in excess of limits pre-agreed in the customer file. The network may recognise the mobile station, comprising control unit, modem and SIM as a system with which it can communicate, in such a way that the mobile station appears to the network to be a fixed line connection. The mobile station is configured to appear to the network to be a fixed line connection, thus avoiding changes to the network configuration to provide for communication with wireless devices. The node may further comprise means for allowing a third party user to intervene in the management of their devices by means of an access arrangement over the public Internet or by other connectivity means.

The invention also relates to a mobile station for use in a communications network. The mobile station comprises means for package switched communication to communicate with the network, the mobile station comprising: at least one unique identity arrangement, at least one GPRS modem device, at least one SIM, at least one control unit or agent. The mobile station further comprises means for receiving information and instructions from a network server via the control unit and the mobile station is configured to call an APN address of a home operator designated in the SIM which is configured to automatically connect the home service provider network and advises a mobile network server attach its unique identity number to ensure secure identification. The unique identity arrangement is International Mobile Equipment Identity (IMEI) number of the mobile station and is used to identify the mobile station. The SIM card has the following characteristics: the SIM card is profiled with the APN address of the home service provider network which acts as a secondary means of identification; the SIM card is SIM card is separate and inserted into a holding slot or imprinted on or embedded directly into the body of the mobile station or modem. The APN address is contained in the control unit and in the customer file in the network server data base. The modem in the device is programmed only to contact the home operator to permit registration and auto-connect of the SIM. The mobile station may be configured to be instructed by the network to connect and/or disconnect a SIM card or chip from service provider networks through their APN addresses. All the APN addresses are contained in a table in the database of a network server. The modem in the mobile station is furnished only with the home operator's APN address profiled in the SIM. The SIM card or chip may be provided inside the device during deployment and reactivated remotely when switched on by the ultimate user and auto connected to the home service provider network. The mobile station may be remotely activated it remains in constant contact with the network via the agent and the user via a back office function. The connection of the SIM card or chip is arranged to be transferred to any other service provider which is connected to the mobile network, whereby the SIM card or chip is configured to be instructed by the network via the agent to disconnect from the home service provider APN profiled in the SIM card or chip; and the SIM card or chip is configured to be instructed by the network via the agent to connect to a designated service provider APN address contained in the server database. The control unit may be pre-programmed prior to deployment with the APN address of the home service provider. The control unit is pre-programmed prior to deployment with the International Mobile Equipment Identity (IMEI) number of the mobile station which is the unique identity number of the device. The control unit may be programmed to execute one or several of: relay information to the SIM and/or the modem as received from the server; set up an (IP) tunnel between the server and the device, or arrange an open session, using UDP or any other MNO protocol over the Internet; communicate with the network server in order to monitor registration and auto connect of the SIM in the device to the home operator's network; assist in registration and auto connect of the SIM in the device to the home operator's network in the event of failure; communicate with a network server in order to provide instructions for the configuration of the device from the rules contained in the server data base; communicate with a network server in order to provide instructions for the transfer of connectivity of the SIM in the device from the home operator's network to another designated network in accordance with the information contained in the customer file and the tables of APN addresses contained in the server data base; instruct the SIM to search for the designated APN and upon registration of the SIM the operator will configure a hand off to the agent to permit the auto connect function to hold the call and reconfigure the device over the air to connect it to the new operator's APN. The agent will then confirm to the mobile network its new connection status. The mobile station may be maintain permanent connection to the network through the modem by using the agent's device management intelligence; communicate with a network server in order to facilitate the transfer of connectivity to another operator using a different technology by means of a ubiquitous interface; communicate with a network server in order to provide instructions for the loading of applications instructions into the device in accordance with the information contained in the customer file and the tables of vertical applications contained in the server data base; disconnect the SIM from the network upon instructions from the network server.

The invention also relates to a server for use in a communications network. The server comprising a processing means and means for storing information about the communications network and communication devices, wherein the processing means is configured to: control data and communication parameters, identify, separate and manage connections to more than one network operator using more than one means of technology, identify, separate and manage many devices of separate manufactures by communicating with a control unit contained in devices. The processing means may further be configured to provide access to information about the network and at least one base station and provide ability to manage aspects of the devices activities and the management of a devices is done by communication with the control unit in the devices and access to the device management is provided to the user by a managing unit linked to the network by the public Internet or by other means. The server is part of the communications network arranged as a gateway to additional connectivity.

The invention also relates to an arrangement for use in a communication device comprising means for storing information, the arrangement comprising: means for storing an unique identity for the device and means for receiving instructions and information from a network server via a programmable agent in the device. The arrangement is configured with the following characteristics: to be distinguished by a service provider APN address; being configured to be instructed by a communication network to connect and/or disconnect the arrangement from a service provider network through its APN being profiled with the home service provider APN address being configured to be instructed by the network to: disconnect for any reason from a specific service provider APN profiled in the arrangement; or connect to a new service provider APN designated by a network server and agent in the arrangement. The arrangement may be one of a SIM card or a chip.

The invention also relates to an arrangement for use in a communication device comprising means for managing a SIM connectivity, device configuration and user applications. The arrangement comprises: means for integrating a control unit into the device so that it is permanently connected to the SIM and a modem and means for receiving information and instructions from a network server to the control unit and relaying the instructions and information to the SIM and the modem in the device. The arrangement may further comprise a control unit being: pre-programmed prior to deployment with the APN address of the home service provider; pre-programmed prior to deployment with the International Mobile Equipment Identity (IMEI) number of the mobile station which is the unique identity number of the device; programmed to communicate with a network server and receive and send instructions and information to the server; programmed to monitor or assist the SIM auto connect function to the home operator; programmed to remain in constant contact with the network server and the user via a back office function; programmed to set up an (IP) tunnel between the server and the device, or arrange an open session, using UDP or any other MNO protocol over the Internet; programmed to translate instructions and information received from the server and relay them in appropriate language to the SIM and the modem; programmed to provide instructions for the configuration of the device from the rules contained in the server data base; programmed to provide instructions and assist in the transfer of connectivity of the SIM from any operator's network to another service provider designated by the mobile network; programmed to provide instructions for the loading of user applications instructions into the device; programmed to collect data and information from the device and relay it to the network server; or programmed to disconnect the SIM from a specific service provider APN in certain circumstances. The arrangement may be one of a SIM card or a chip.

The invention also relates to an arrangement for use in a communications network comprising means for providing access to an end user to manage SIM connectivity, device configuration and user applications, the arrangement comprising: means to provide access to information about the communications network and at least one base station and provide the user with ability to manage all characteristics of mobile stations' activities through an interface linked to the network by a public communication network. The arrangement may be configured so that the communications network is linked to a managing entity which has total visibility of all aspects of the network and all devices which are deployed on it. The arrangement may be configured to communicate with a server arranged to control and interface to the managing entity to provide access to information about the network, base station and all mobile stations. The managing entity connects to the mobile network site either directly through the server, through a WEB site at the mobile network site, through a controlling unit, or through a wireless gateway. The arrangement may be configured so that the managing entity comprises a back office management function arranged to provide information to 3^{rd} party users concerning the status of all mobile devices, the data which is flowing through them and billing, statistical and other available information which the function is requested to provide. The arrangement may, comprise an interface providing a 3^{rd} party user with direct control of the SIM and the device via the server and the agent and are thus fully in control of all of the SIMs, devices and data handled by the network. The arrangement may be one of a SIM card or a chip.

The invention also relates to a method for providing package switched communication ability in a mobile communications network, the method comprising the steps of: arranging one or several mobile stations, providing communication with the mobile stations through one or several service providers, allowing a user to communicate with the mobile stations, arranging the mobile communications network to remotely provide the mobile stations with configuration, connectivity and applications information and instructions from a server communicating with a programmable agent or control unit in the mobile stations.

### BRIEF DESCRIPTION OF THE DRAWINGS

In the following, the invention will be further described in a non-limiting way with reference to the accompanying drawings in which:

FIG. 1 schematically illustrates a mobile communication network according to the present invention,

FIG. 2 is a schematic illustration of a mobile station according to the present invention, equipped with a standard SIM, a standard modem and an agent,

FIG. 3 is a general block diagram of the invention,

FIG. 4 is a diagram of a connection between the network server and a device to provide or receive information or instructions to/from an agent which is connected to the SIM and the modem.

### DETAILED DESCRIPTION

Briefly, the invention relates to the ability to utilise Internet capabilities within a communications network in order to remotely instruct and manage mobile devices as in respect of providing configuration and applications instructions to the device and to also seamlessly manage service providers' connectivity to mobile devices and “attach” them to the designated service provider. These instructions are contained in the data base of a network server and are retrieved, communicated to and implemented via the modem in the device by an agent, e.g. a control unit, a microprocessor or the like, incorporated into the device. The system according to one embodiment may comprise:
One or several (standard) General Packet Radio Service (GPRS) network, which can be provided by any mobile operator,
One or several non GPRS network which can be a satellite network and can be provided by any non GPRS or satellite network operator,
One or several (standard) GPRS modem engine,
One or several (standard) SIM card, which can be provided by any manufacturer, or which may be embedded into the modem engine,
One or several programmable agents, which may be a control unit or microprocessor, which may be embedded into the modem engine or into an electronics carrier, such as a printed circuit board of the device.

One basic gap in the existing GPRS offers ability to remotely manage devices and SIMs without constant recourse to the service provider. The invention uses an intelligent ‘agent’ which is a programmable control unit integrated into the modem or device which communicates with a network server to create a permanent link between the Internet and wireless domains.

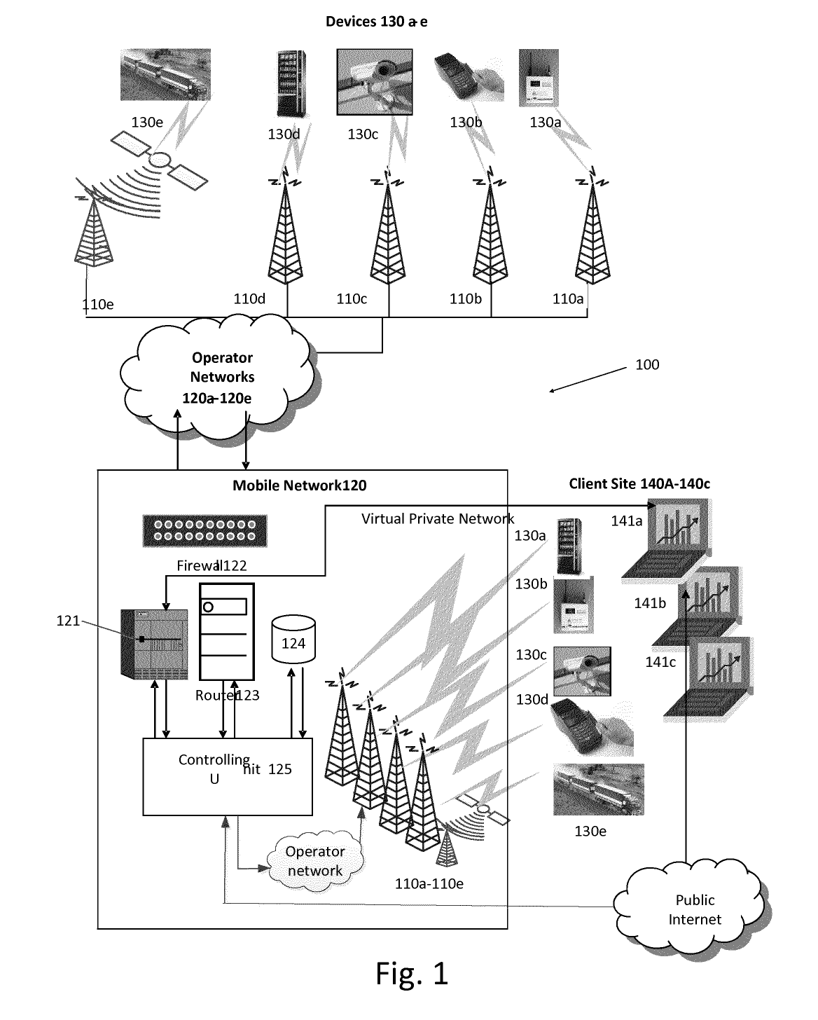

FIG. 1 illustrates a communications network 100 according to the invention. The communications network 100 comprises a number of service providers and operator networks 110a-110e, linked to a mobile network 120, a number of mobile stations 130a-130e and a number of clients' sites 140a-140c. The client sites 140a-140c may include computer units 141a-141c.

The operator networks 110a-110e may be any of a mobile or cellular communications network such as Global System for Mobile Communications (GSM), Universal Mobile Telecommunications System (UMTS), General Packet Radio Service (GPRS), Code-Division Multiple Access ( ) or Enhanced Data GSM Environment (EDGE), or the like. The operator network allows package-based communication. An operator network, e.g. 120e, can also be a non-cellular network such as a satellite network.

The mobile stations 130a-130e may comprise any type of communication devices adapted for communication with the operator's network. Thus, a mobile station may comprise a transceiver, transmitter, camera, and may be part of a mobile phone, computer, Personal Digital Assistance (PDA), container tracking device 130e, goods distribution automat 130d, monitoring camera 130c, credit card reader 130b, measuring/monitoring devices 130a such as electricity meter, alarms, etc.

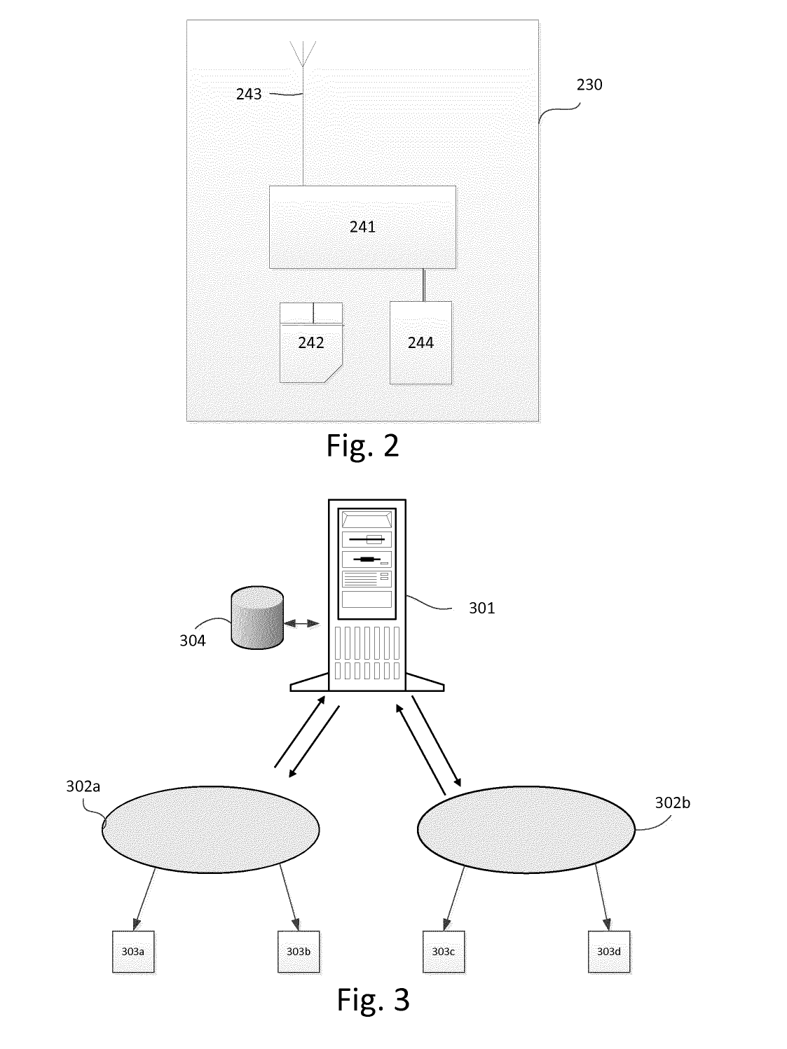

Each mobile station 240, as illustrated in the exemplary embodiment of FIG. 2, comprises a communication part or modem 241, a SIM card 242, an antenna 243, an agent 244. The agent is a programmable micro processor which acts as a control unit or device management system in an ordinary fashion including memory and other parts needed for the control of the mobile station. The SIM card may be a standard card according to the invention and includes the APN profile of the home service provider, which is the original service provider which issued the SIM and which is one of the providers connected to the mobile network. The SIM card may comprise other functionalities not relevant for the invention. The SIM card may be imprinted on or embedded directly into the body of the mobile station or modem.

The communication part, or modem, is a standard modem according to the invention and includes basic NAT instructions for SIM auto connect function to the APN of the home service provider profiled in the SIM and subsequent implementation of two-way communication between the device and the mobile communications network.

The agent is a programmable micro processor according to the invention and includes the APN of the home service provider profiled in the SIM and instructions for SIM auto connect function and subsequent implementation of two-way communication between the device and the mobile communications network.

The agent can, via the modem, subsequent to implementation of two-way communication, provide information and identification of the device to and receive instructions from a network server based upon tables contained in a data base concerning SIM connectivity, network technology, device configuration and applications instructions in accordance with the user requirements.

The agent may be embedded into the modem or into the electronics carrier, eg into the printed circuit board which connects the modem and the SIM and is thus an integral part of the device, being connected to both the modem and the SIM.

The agent may be programmed in C++, Java or any other programming language suited to the purpose.

The mobile stations can be used as a mobile phone or as transmitter/receiver attached to monitoring or control devices, such as for fire detectors, CCTV cameras, alarms, control units, measuring units, robots, EPOS swipe card devices, vehicle telematics equipment, etc.

Moreover, the mobile station comprises package switched communication ability to communicate with the network, and further comprises: a SIM card or identity chip, and a GPRS modem or chip. The mobile station is arranged so that the agent can receive data and instructions from a server via the modem and acting as a control unit can translate and transmit the information in the appropriate language to the SIM card or modem. The agent can be instructed from the server to connect a number of incoming analogous and/or digital data inputs to a package switched output, specially a General Packet Radio Service (GPRS) based output. The SIM card may be imprinted on or embedded directly into the body of the mobile station or modem. The agent may be embedded into the modem or into the electronics carrier, eg the printed circuit board of the device.

The mobile station can be pre-tested in a factory or assembly plant with a SIM card inserted by connecting to the home service provider network, activating the connection to the network and operating the device in trial mode. The mobile station can be prepared for shipment by deactivating the connection to the service provider network and leaving the SIM card in the device. This is called shipping the device in sleeping mode. When the mobile station arrives in the hands of the user and is switched on, via the modem it will register with the home network profiled in the APN of the SIM and signal that it is ready for activation, identifying itself by means of the unique identity arrangement, which can be the International Mobile Equipment Identity (IMEI) number of said mobile station and which is stored in the modem and the agent. The mobile station can be remotely activated and auto connected to the home service provider network which is profiled in the SIM card thus converting the device from sleeping mode to active mode. In the event that the auto connect function fails, the agent can assist with the connection by means of the information programmed into it prior to deployment. When the mobile station is remotely activated it will remain in constant contact with the network and can be managed by the user via the agent and the back office management platform function.

Returning now to FIG. 1, the mobile network site 120 comprises a server 121 (one or several) for running applications, such as FTP server, Radius server, encryption/decryption, compression etc. The server also keeps track of unique identity addresses of the mobile stations, APN addresses, network technology types, device types and customer information in a data base 124 as mentioned above.

The site 120 also comprises a gateway or router 123 to manage the connections and data flowing between the server(s) and the service providers.

The site 120 also comprises a firewall 122 (one or several) which contains the main rules of management of the server site and manages the communications between the network and the mobile stations in the Internet domain or connected by other means as instructed by a management platform connected to the network or otherwise.

The server may be ????? computer comprising processor(s), memory(ies), mass storage, internal and external interaction interfaces all arranged and operated in ways well known for a skilled person.

The firewall is arranged to provide the rules of the interaction of the servers with the routers, the data base, the Internet, the VPNs and all other elements of the service provider site.

The firewall also acts as a first line of defense and security to all parts of the service provider site and the connections with the service providers.

The server 121 may comprise a package operating system and means for converting input data to GPRS data, standard hardware and the ability to store information about the network and mobile station. The server further comprises: a dedicated and special instruction set package to control the data and communication parameters, a server based software for the decryption algorithms, a server based software for the decompression algorithms. The server is connected to a data base storage, which holds customer information and tables of APN addresses of service providers which are connected to the network and tables and instructions relating to various types of technology, various devices and applications to be implemented into them in accordance with customer or service provider requirements.

Preferably, the server will store the information related to a customer and their devices in the data base 124 in groups for that user and separately from other groups allocated to other users.

Moreover, the server is arranged to control and interface to a 3^{rd} party user to provide access to information about the network, base station and all mobile stations, via a management platform connected to the Internet or by other means.

The interface provided to a 3^{rd} party user may be via a back office management function using IP tunnelling through a Virtual Private Network, (VPN), over the Public Internet, whereby the information is provided on a web based screen or by other means. The back office management system can restrict access to the data being provided in accordance with the rules of the 3^{rd} party user.

Preferably, the back office management function is arranged to provide information to 3^{rd} party users concerning the status of all mobile devices, the data which is flowing through them and billing, statistical and other available information which the function is requested to provide.

The interface provides the 3^{rd} party user with direct control of the SIM and the device via the server and hence the agent for the configuration and management of the SIM and the device wherever they may be located so that they can assign or reassign operator APNs, device configuration rules and customer applications instructions directly as they activate mobile devices and are thus fully in control of all of the SIMs, devices and data handled by the network.

The server is part of the network and is arranged to manage 3^{rd} party user VPNs or other 3^{rd} party connections and is thus the gateway to 3^{rd} party connectivity.

The client site 140 may include computer units 141, e.g. for sending, receiving and monitoring the mobile stations. The computer unit connects to the service provider site directly through, e.g. PSTN, through the server 121, through a WEB site at the service provider site, through controlling unit 125 or wirelessly through gateway 130, e.g. using GPRS.

FIG. 3 is a block diagram illustrating one aspect of the invention, in which a central server 301 is arranged to manage the SIM and device configurations which are stored in the data base 304 managed by the server. They are provided to a router (s) 302. The router transfers the instructions to the agent in the clients' mobile stations 303a-303d, and when received by the clients, they can connect directly (through the Internet or other connection to the network) as if the device was on a fixed line and not wireless. The APNs and other device management instructions can be assigned and reassigned by the clients through the agent to the SIM and the modem using the tables and information from the server data base via the back office management function.

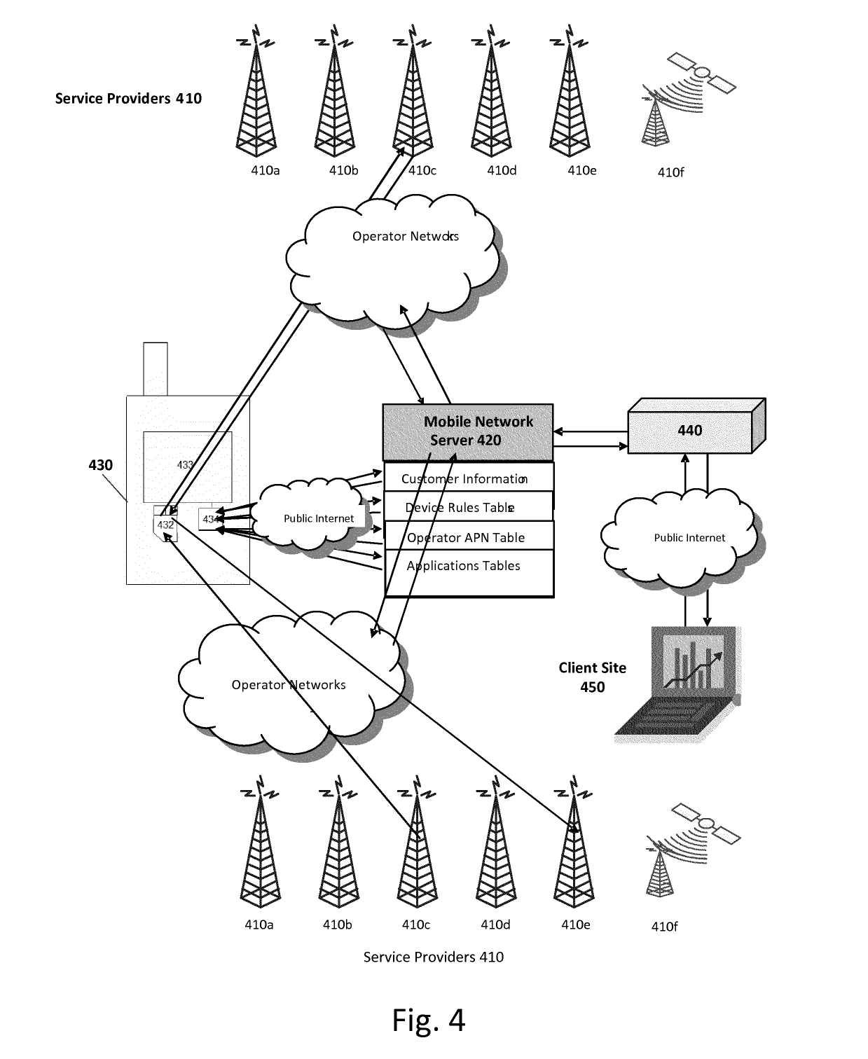

FIG. 4 is a diagram of a network according to one embodiment of the invention where a mobile network is connected to six service providers 410a-410f, all of which are available to provide service to the mobile station 430, wherein the SIM 432 is profiled with the APN address of the home service provider network, e.g. 410c. The SIM card may be imprinted on or embedded directly into the body of the mobile station or modem.

The mobile station 430 also comprises a modem 433 which is a wireless transceiver and acts as the communications part of the device and is integrally connected to the SIM. The modem may not be programmed prior to deployment with any instructions or information except for transmission and reception of data input and output.

The mobile station also incorporates an agent 434 which carries the APN of the home service provider network, 410c. As mentioned earlier, the agent may comprise a programmable microprocessor and may be embedded in the modem or into the electronics carrier, eg a printed circuit board which is also connected to the SIM and the modem so that the three elements are integrally connected and are seen as one system by the network. Preferably the agent may be programmed in C++, Java or any other programming language suited to the purpose.

When the device is activated, the modem 433 calls the APN address of the home operator designated in the SIM 432 which auto connects to home service provider network 410c. It advises the mobile network server 420, and the user 450, e.g. via the software platform back office function 440, attaching its unique identity number to ensure secure identification.

Preferably the user 450 (client site) will be accessed by the network and vice versa by connection to the management platform 440 via an IP tunnelling process through a Virtual Private Network (VPN) or by other means.

Preferably the server of the mobile network will match the unique identity number of the device to a customer record contained in the server database and see the SIM, modem and agent as a system where instructions are sent and will enter into communications with the agent, which also contains the APN address and the unique identity number because it is an integral part of the device, connected directly to the SIM and the modem. The server will research the customer records and the tables contained in its data base and will communicate to the agent the instructions which are needed to configure the device in accordance with the user requirements. These instructions may include, but are not limited to:
Configuration rules for that specific device manufacture and required by the technology used by that service provider,
Instructions for the user applications to be executed by the device,
The APN address of the designated service provider,
Any other information which the device requires in order to execute its functions in an efficient and cost effective manner.

In one embodiment the agent may be programmed to receive information from the server via an (IP) tunnel to be set up between any third party user and the device, or via an open session, using UDP or any other MNO protocol over the Internet or by other means, then to translate the information and relay it in language used by the SIM and the device.

In one embodiment the agent can assure that the device is configured in accordance with the instructions received from the server and can immediately commence execution of its applications and continuously communicate information to the server via the appropriate service provider's APN.

In one embodiment the server will be equipped with a ubiquitous interface, which will permit the agent in the device to receive instructions suitable to configuration for any network technology such as Global System for Mobile Communications (GSM), Universal Mobile Telecommunications System (UMTS), General Packet Radio Service (GPRS) or Enhanced Data GSM Environment (EDGE), or the like, or any generation thereof, eg 2G, 3G, 4G.

In one embodiment the management platform 440 will be connected to the mobile network 420 and will provide information from the server to the user 450 and instructions from the user to the server to be communicated to the mobile station 430.

In one embodiment, if the designated service provider is not the home operator's network, the agent can act as a management device to enable the SIM to contact the appropriate new APN address and auto connect to this network, as shown in FIG. 4 where the home operator's network is 410c and the designated service provider network is, e.g. 410e.

The agent will instruct the SIM to search for APN 410e and upon registration of the SIM the operator will configure a hand off to the agent to permit the auto connect function to hold the call and reconfigure the device over the air to connect it to the new operator's APN. The agent will then confirm to the mobile network its new connection status. The mobile station will maintain permanent connection to the network through the modem by using the agent's device management intelligence linked to the mobile network's server.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be implemented at least in part by means of both hardware and software, and that several “means”, “units” or “devices” may be represented by the same item of hardware.

A “device” as the term is used herein, is to be broadly interpreted to include any type of mobile station,; a radiotelephone; a personal communications system (PCS) terminal that may combine a cellular radiotelephone with data processing; a personal digital assistant (PDA) that can include a radiotelephone or wireless communication system; a laptop; a camera having communication ability; and any other computation or communication device capable of transceiving, such as a personal computer, a home entertainment system, a television, teller machine etc.

The various embodiments of the present invention described herein is described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments of the present invention can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments of the present invention, have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

The invention is not limited to the shown embodiments but can be varied in a number of ways without departing from the scope of the appended claims and the arrangement and the method can be implemented in various ways depending on application, functional units, needs and requirements etc.

1. A mobile communications network having package switched communication ability, the communication network comprising:
one or several service provider servers, providing communication through one or more networks with the communications network,
one or several mobile stations which can be connected to any of said networks,
characterised in that the mobile communications network node comprises a controller to provide at least one mobile station with instructions contained in a database communicating with the controller, wherein said mobile station comprises an agent, comprising a programmable control unit comprising a programmable control unit integrated in a modem of the mobile station, which is configured to communicate with a network server, which remotely manages said mobile station and SIM of said mobile station to create a permanent link between internet and wireless domains, and configured to provide instructions for the configuration and management of the mobile station.

2. The network of claim 1, wherein said database contains at least one of:
tables of Access Point Name, APN, addresses of operator networks connected to the mobile communications network;
a ubiquitous interface to facilitate configuration of devices in accordance with the technology used by the operator networks;
tables of configuration rules of various types of modems in mobile stations from various manufacturers;
tables of instructions in respect of many vertical industry applications; or
customer files containing the unique identity number of all customer devices deployed upon the network.

3. The network of claim 2, wherein said unique identity is International Mobile Equipment Identity, IMEI, number of said mobile stations.

4. The network of claim 2, wherein said server further stores information about one or several of:
an APN address of a home service operator's network profiled into a SIM in each mobile station;
designated APN addresses for SIM connectivity of all mobile stations, according to their geographical and/or additional aspects of deployment, including network technology;
configuration of all mobile stations in accordance with a manufacturer's and user requirements; and
applications instructions for all mobile stations in accordance with user requirements.

5. The network of claim 1, wherein said server is configured to communicate with said agent via a modem by means of an IP-tunnel to be set up between the server and the device, or via an open session, using Users Datagram Protocol, UDP, or a Mobile Network Operator, MNO, protocol over the Internet.

6-13. (canceled)

14. A mobile station for use in a communications network, said mobile station comprising:
means for package switched communication
at least one unique identity arrangement,
at least one GPRS modem device,
at least one SIM, and
at least one control unit or agent,
characterised in that said mobile station is programmable and integrated into the modem, which is configured to communicate with a network server to obtain instructions contained in the database of the network and to be remotely instructed and managed to create a permanent link between internet and wireless domains, and the mobile stations further comprises a receiver for receiving information and instructions from a network server via the control unit, and the mobile station is configured to call an APN address of a home operator designated in the SIM which is configured to automatically connect said home service provider network and advises a mobile network server to attach its unique identity number to ensure secure identification.

15. The mobile station of claim 14, wherein said unique identity arrangement is International Mobile Equipment Identity (IMEI) number of said mobile station and is used to identify the mobile station.

16. The mobile station of claim 14, wherein said SIM card is:
profiled with the APN address of the home service provider network which acts as a secondary means of identification;
separate and inserted into a holding slot or imprinted on or embedded directly into the body of the mobile station or modem.

17. The mobile station of claim 14, wherein said APN address is contained in the control unit and in a customer file in the network server data base.

18. The mobile station of claim 14, wherein the modem in the device is programmed only to contact the home operator to permit registration and auto connect of the SIM.

19. The mobile station of claim 14, configured to be instructed by the network to connect and/or disconnect a SIM card or chip from service provider networks through their APN addresses.

20. The mobile station of claim 14, wherein all said APN addresses are contained in a table in the database of a network server.

21. The mobile station of claim 14, wherein the modem is furnished only with the home operator's APN address profiled in the SIM.

22. The mobile station of claim 14, wherein said SIM card or chip is arranged inside the device during deployment and reactivated remotely when switched on by the ultimate user and auto connected to the home service provider network.

23. The mobile station of claim 14, wherein when said mobile station is configured to be remotely activated and remain in constant contact with the network via the agent and the user via a back office function.

24. The mobile station of claim 14, wherein the connection of said SIM card or chip is arranged to be transferred to any other service provider which is connected to the mobile network, whereby said SIM card or chip is configured to be instructed by the network via the agent to disconnect from the home service provider APN profiled in the SIM card or chip, and wherein said SIM card or chip is configured to be instructed by the network via the agent to connect to a designated service provider APN address contained in the server database.

25-26. (canceled)

27. The mobile station of claim 14, wherein said control unit is programmed to execute at least one of:
relay information to the SIM and/or the modem as received from the server;
set up an (IP) tunnel between the server and the device, or arrange an open session, using UDP or any other MNO protocol over the Internet;
communicate with the network server in order to monitor registration and auto connect of the SIM in the device to the home operator's network;
assist in registration and auto connect of the SIM in the device to the home operator's network in the event of failure;
communicate with a network server in order to provide instructions for the configuration of the device from the rules contained in the server data base;
communicate with a network server in order to provide instructions for the transfer of connectivity of the SIM in the device from the home operator's network to another designated network in accordance with the information contained in the customer file and the tables of APN addresses contained in the server data base;
instruct the SIM to search for the designated APN and upon registration of the SIM the operator will configure a hand off to the agent to permit the auto connect function to hold the call and reconfigure the device over the air to connect it to the new operator's APN, wherein the agent then confirms to the mobile network its new connection status, and the mobile station maintains permanent connection to the network through the modem by using the agent's device management intelligence;
communicate with a network server in order to facilitate the transfer of connectivity to another operator using a different technology by means of a ubiquitous interface;
communicate with a network server in order to provide instructions for the loading of applications instructions into the device in accordance with the information contained in the customer file and the tables of vertical applications contained in the server data base; and
disconnect the SIM from the network upon instructions from the network server.

28-42. (canceled)

43. A node in a mobile communications network, having package switched communication ability, characterised in that the node comprises a controller configured to provide a mobile station with instructions contained in a database of the node communicating with the controller, wherein said mobile station comprises an agent, comprising a programmable control unit integrated in a modem of the mobile station, which is configured to communicate with said node, which is configured to provide instructions for the configuration and management of the mobile station and to remotely manage said mobile station and SIM of said mobile station and create a permanent link between internet and wireless domains.

44. The node of claim 43, wherein said database contains at least one of:
tables of Access Point Name, APN, addresses of operator networks connected to the mobile communications network;
a ubiquitous interface to facilitate configuration of devices in accordance with the technology used by the operator networks;
tables of configuration rules of various types of modems in mobile stations from various manufacturers;
tables of instructions in respect of many vertical industry applications; and
customer files containing the unique identity number of all customer devices deployed upon the network.

45. The node of claim 43, wherein said server further contains information concerning at least one of:
an APN address of a home service operator's network profiled into a SIM in each mobile station;
designated APN addresses for SIM connectivity of all mobile stations according to their geographical and/or additional aspects of deployment, including network technology;
configuration of all mobile stations in accordance with a manufacturer's and user requirements; or
applications instructions for all mobile stations in accordance with user requirements.
